(19) United States
(12) Patent Application Publication
(10) Pub. No.: US 2026/0328267 A1
(43) Pub. Date: Oct. 22, 2026

(54) DUAL CLUTCH TRANSMISSION, DRIVE ASSEMBLY AND WORKING MACHINE

(71) Applicant: DEERE & COMPANY, MOLINE, IL (US)

(72) Inventors: MATTHIAS LANG, MANNHEIM (DE); RAINER GUGEL, PLANKSTADT (DE); DAVID MUELLER, DETTENHEIM (DE); STEFAN RAISCH, VAIHINGEN AN DER ENZ (DE)

(21) Appl. No.: 19/544,494

(22) Filed: Feb. 19, 2026

(30) Foreign Application Priority Data
Apr. 22, 2025 (EP) 25171570.2

(51) Int. Cl. F16H 3/00; B60K 17/02; B60K 17/08; B60K 17/28; F16H 37/08

(52) U.S. Cl. CPC F16H 3/006; B60K 17/08; B60K 17/28; F16H 37/0806; B60K 17/02; F16H 2200/0004; F16H 2200/0043

(57) ABSTRACT

A dual clutch transmission for a drive assembly of a working machine includes a first shifting element connected to a first transmission input shaft, a second shifting element connected to a second transmission input shaft, and a plurality of spur gear stages, the first transmission input shaft connected to an output shaft by at least one of the plurality of the spur gear stages, second transmission input shaft connected to the output shaft by at least one of the plurality of the spur gear stages, and the plurality of spur gear stages including a first spur gear stage having a first fixed gear disposed on the first transmission input shaft, a first shifting gear disposed on the output shaft, and a reverse idler gear disposed between the first fixed gear and the first shifting gear.

### CROSS-REFERENCE TO RELATED APPLICATIONS

This application claims priority to European Patent Application No. 25171570.2, filed Apr. 22, 2025, which is hereby incorporated by reference.

### FIELD OF THE DISCLOSURE

The disclosure relates to a dual clutch transmission, drive assembly, and working machine.

### BACKGROUND

For a long time, drive assemblies have been used in working machines in order to be able to vary the propulsion of the working machine without interruption, even under a high towing load, for example caused by an implement such as a tilling apparatus (e.g. plough) or the like, attached thereto, by simply varying the rotating speed of the drive motor. In this context, the drive assembly can be for example a powershift drive assembly. A known measure is to increase the number of gear stages of a drive assembly by said assembly comprising a combination of transmissions, for example by combining a transmission device with a dual clutch transmission. DE 10 2013 110 709 A1 discloses such a drive assembly. The dual clutch transmission used therein can in turn be disclosed in WO 2009/050078 A2.

### SUMMARY

According to an aspect of the present disclosure, a dual clutch transmission for a drive assembly of a working machine includes a first shifting element connected to a first transmission input shaft, a second shifting element connected to a second transmission input shaft, and a plurality of spur gear stages, the first transmission input shaft connected to an output shaft by at least one of the plurality of the spur gear stages, second transmission input shaft connected to the output shaft by at least one of the plurality of the spur gear stages, and the plurality of spur gear stages including a first spur gear stage having a first fixed gear disposed on the first transmission input shaft, a first shifting gear disposed on the output shaft, and a reverse idler gear disposed between the first fixed gear and the first shifting gear.

According to an aspect of the present disclosure, the plurality of spur gear stages includes a second spur gear stage, a third spur gear stage, and a fourth spur gear stage, the second spur gear stage has a second fixed gear disposed on the first transmission input shaft and a second shifting gear disposed on the output shaft, the third spur gear stage has a third fixed gear disposed on the second transmission input shaft and a third shifting gear disposed on the output shaft, and the fourth spur gear stage has a fourth fixed gear disposed on the second transmission input shaft and a fourth shifting gear disposed on the output shaft.

According to an aspect of the present disclosure, a drive assembly for a working machine includes a dual clutch transmission disclosed herein and a range transmission disposed in the power flux upstream of the dual clutch transmission.

According to an aspect of the present disclosure, the range transmission includes one of a single-stage transmission, a multi-stage transmission, or a continuously variable transmission.

According to an aspect of the present disclosure, the drive assembly includes an input shaft, a first energy machine connected to the input shaft, and a second energy machine, the range transmission includes a first input side, a second input side connected to the second energy machine, and a first output side connected to the dual clutch transmission.

According to an aspect of the present disclosure, the drive assembly includes a drive unit connected to the input shaft.

According to an aspect of the present disclosure, the range transmission includes an epicyclic transmission stage.

According to an aspect of the present disclosure, the drive assembly includes a set of power electronics by which electrical power is transmissible between the first energy machine and the second energy machine.

According to an aspect of the present disclosure, the drive assembly includes a decoupler disposed between the drive unit and the range transmission or between the drive unit and the first energy machine.

According to an aspect of the present disclosure, the drive assembly includes a control unit, including a processor and memory, configured to operate the drive assembly.

According to an aspect of the present disclosure, the input shaft is connected to a first power output including a PTO shaft.

According to an aspect of the present disclosure, a work machine includes any of the embodiments or implementations of a dual-clutch transmission or drive assembly disclosed herein.

The above and other features will become apparent from the following detailed description and accompanying drawings.

### BRIEF DESCRIPTION OF THE DRAWINGS

The disclosure and further advantages and advantageous refinements and design embodiments of the disclosure, both in terms of hardware and in terms of method, will be explained in more detail hereunder by means example embodiments and with reference to the drawing. Components with identical or comparable function herein are identified by the same reference signs. In the drawings:

FIG. 1 shows a schematic illustration of a first example embodiment of a working machine according to the disclosure;

FIG. 2 shows a schematic illustration of a first example embodiment of a dual clutch transmission according to the disclosure;

FIG. 3 shows a schematic illustration of a second example embodiment of a dual clutch transmission according to the disclosure;

FIG. 4 shows a schematic illustration of a first example embodiment of the drive assembly according to the disclosure;

FIG. 5 shows a schematic illustration of a second example embodiment of the drive assembly according to the disclosure;

FIG. 6 shows a schematic illustration of a third example embodiment of the drive assembly according to the disclosure;

FIG. 7 shows a schematic illustration of a fourth example embodiment of the drive assembly according to the disclosure;

FIG. 8 shows a schematic illustration of a fifth example embodiment of the drive assembly according to the disclosure;

FIG. 9 shows a schematic illustration of a sixth example embodiment of the drive assembly according to the disclosure; and

FIGS. 10-11 show schematic illustrations of further example embodiments of the drive assembly according to the disclosure.

### DETAILED DESCRIPTION

The embodiments or implementations disclosed in the above drawings and the following detailed description are not intended to be exhaustive or to limit the present disclosure to these embodiments or implementations.

A disadvantage of the known drive assemblies is that the required installation space is excessive. Moreover, in recent years, working machines have also become established, for example in the field of agricultural tractor vehicles, with drive assemblies which are designed as continuously variable transmissions. Continuously variable transmissions are usually embodied in power-split form with a variable hydraulic path. In order to construct continuously variable transmissions with comfortable shifting procedures that are not perceptible or hardly perceptible by the person in control of the vehicle, it is necessary in this case to provide two variable speed gear outputs which are shifted at the synchronization point. This disadvantageously leads to a degree of complexity in the drive assembly.

Furthermore, it is disadvantageous that the reverse gear in the drive assembly or in the dual clutch transmission, that is to say for example a reversal of the direction of rotation of the drive assembly, takes up a large amount of installation space. Specifically, the achievable and actually achieved speeds should also reach approximately the same level in reverse operation as in forward operation (that is to say that at constant engine speed, the occurring speeds before and after the shifting procedure should be approximately the same in terms of absolute value).

Proceeding from this prior art, it is an object of the present disclosure to propose a drive assembly which is improved in comparison to the prior art, and a working machine. Specifically, it is an object of the present disclosure to propose a drive assembly and a working machine which are configured structurally in a simpler and/or more compact manner and/or require less installation space and/or are less complex and/or improve reverse operation.

This object is achieved by a dual clutch transmission having the features of one or more embodiments disclosed herein, by a drive assembly having the features of one or more embodiments disclosed herein, and by a working machine having the features of one or more embodiments disclosed herein. One or more embodiments disclosed herein can relate to particularly advantageous embodiments of the disclosure.

Proposed according to the disclosure is a dual clutch transmission for a drive assembly, for example for a continuously variable transmission with an electrical variable path, for example as an input-coupled structure, or for a working machine. The dual clutch transmission comprises a first and a second shifting element, for example the first and second clutches, wherein the first shifting element is connectable or connected to a first transmission input shaft, and the second shifting element is connectable or connected to a second transmission input shaft. The dual clutch transmission comprises several or a plurality of spur gear stages, for example a first and a second and a third and a fourth spur gear stage. The first and/or the second transmission input shaft is connectable, or connected, to an output shaft by way of one or a plurality of the spur gear stages, for example so as to establish transmission stages. Moreover, at least one winding path gear stage is able to be formed, or is formed, with the dual clutch transmission. One of the spur gear stages comprises a reverse idler gear. A spur gear stage can comprise a fixed gear which is co-rotationally disposed on the first or the second transmission input shaft, and a shifting gear which is rotatably disposed on the output shaft. Alternatively, a spur gear stage can comprise a fixed gear co-rotationally disposed on the output shaft, and a shifting gear which is rotatably disposed on the first or second transmission input shaft. “Connected” can for example be understood to mean mechanically connected and/or mechanically operatively connected and/or co-rotationally connected. Specifically, the term connected is additionally or alternatively understood to mean drivably connected, thus connected in a torque- and/or rotating speed-transmitting manner, and/or coupled, thus for example mechanically coupled and/or rigidly coupled and/or co-rotationally coupled. “Connectable” can for example be understood to mean mechanically connectable and/or mechanically operatively connectable and/or co-rotationally connectable. Specifically, the term connectable is additionally or alternatively understood to mean drivably connectable, thus connectable in a torque- and/or rotating speed-transmitting manner, and/or couplable, thus mechanically couplable and/or rigidly couplable, and/or co-rotationally connectable. The term connected can thus specifically be understood to mean a connection between two components, which enables energy and/or force and/or torque and/or rotating speed to be transmitted from the one component to the other component, for example by mechanical means. Further components or parts enabling such a transmission of energy and/or force and/or torque and/or transmission of a rotating speed between the two components can be provided between the two components.

The shifting elements, for example the first and/or the second and/or a third and/or a fourth shifting element, and/or further shifting elements and/or a decoupler and/or a coupling device can be connected for signalling and/or operatively coupled, and/or connected for signal transmission and/or data transmission, to the control unit. Specifically, each shifting element can comprise a valve or a valve assembly, for example a control valve, or an actuator for actuating and/or setting and/or adjusting the respective assigned shifting element. The valve or the valve assembly or the actuator can be connected and/or operatively coupled to the respective assigned shifting element. The control unit can be connected for signalling and/or operatively coupled and/or connected for signal transmission and/or data transmission, to the valve or the valve assembly or the actuator of the respective assigned shifting element. The control unit can be configured to actuate and/or set and/or adjust the shifting element, for example by way of the respective assigned valve or the valve assembly or the actuator. The control unit can be configured to set and/or adjust the shifting element, for example by way of the respective assigned valve or the valve assembly or the actuator, to the first position, thus the opened state, or the second position, thus the closed state, for example also to move it from the first position into the second position and vice versa.

A shifting element, for example the first and/or the second and/or a third and/or a fourth shifting element, and/or further shifting elements and/or the decoupler and/or the coupling device, can be understood to mean a connecting part by means of which at least one part which transmits energy and/or force and/or torque and/or speed can be connected in a driving manner with a further part which transmits energy and/or force and/or torque and/or speed or to a part which is fixed in a location or in the housing. The respective shifting element is shiftable between at least an opened state and a closed state, wherein the shifting element in the opened state can transmit neither energy nor force nor torque nor rotating speed between two parts that interact with the shifting element, and wherein the shifting element in the closed state can transmit energy and/or force and/or torque and/or rotating speed between the two parts that interact with the shifting element. If there is a connection, for example an operative connection, between two elements or components of the drive assembly, energy and/or force and/or torque and/or rotating speed are/is transmitted from one element or one component to the other element or the other component. The shifting element, for example the first and/or the second and/or a third and/or a fourth shifting element, and/or further shifting elements and/or the decoupler and/or the coupling device can be a clutch, for example a multi-disk clutch, and/or a brake and/or a synchronization mechanism and/or a dog clutch. Specifically, the first and/or the second and/or a third and/or a fourth shifting element and/or further shifting elements and/or the decoupler and/or the coupling device can be designed as multi-disk clutches (or as dry single-disk clutches), for example as friction clutches. However, the first and/or the second and/or a third and/or a fourth shifting element and/or further shifting elements and/or the decoupler and/or the coupling device can also be designed as non-powershift clutches.

The dual clutch transmission can comprise the first shifting element, for example a first clutch, and the second shifting element, for example a second clutch. The input side, or the input sides, of the first and/or the second shifting element, for example of the first and the second clutch, can be a third input side. The first and/or the second shifting element, for example the first and/or the second clutch, and the first and/or the second transmission input shaft, can be disposed so as to be axially parallel to and/or coaxial with one another. The third input side of the dual clutch transmission can be connectable, or connected, for example directly or indirectly to a first output side of a transmission device. The dual clutch transmission can be disposed in the power flux downstream of the transmission device. Specifically, the first output side can be connectable, or connected, to the first transmission input shaft by way of or through the first shifting element, and/or be connectable, or connected, to the second transmission input shaft by way of or through the second shifting element.

The first shifting element, for example the first clutch, can be movable and/or shiftable between an opened state, in which no rotating speed and/or no torque is transmitted to the first transmission input shaft, and a closed state, in which a rotating speed and/or a torque is transmitted to the first transmission input shaft. Specifically, the first shifting element, for example the first clutch, can be movable and/or shiftable between an opened state, in which the first output side is released in terms of drive from the first transmission input shaft, and a closed state, in which the first output side is in drive connection with the first transmission input shaft, thus connected thereto. The second shifting element, for example the second clutch, can be movable and/or shiftable between an opened state, in which no rotating speed and/or torque is transmitted to the second transmission input shaft, and a closed state, in which a rotating speed and/or a torque is transmitted to the second transmission input shaft. Specifically, the second shifting element, for example the second clutch, can be movable and/or shiftable between an opened state, in which the first output side is released in terms of drive from the second transmission input shaft, and a closed state, in which the first output side is in drive connection with the second transmission input shaft, thus connected thereto.

The dual clutch transmission can have several or a plurality of spur gear stages, for example at least two, four, for example exactly four, or a plurality of spur gear stages, for establishing transmission stages, for example group transmission stages. The dual clutch transmission can have one or more spur gear stages with in each case one fixed gear co-rotationally disposed on the first or the second transmission input shaft, and in each case one shifting gear rotatably disposed on the output shaft and/or one or a plurality of spur gear stages with in each case one fixed gear co-rotationally disposed on the output shaft, and in each case one shifting gear rotatably disposed on the first or the second transmission input shaft. The shifting gears, for example gearwheels or gear wheels, can be disposed and/or mounted, for example rotatably disposed and/or rotatably mounted, on the output shaft and/or the first and/or the second transmission input shaft. Fixed gears, for example gearwheels, can be disposed, for example co-rotationally disposed on the first and/or the second transmission input shaft and/or the output shaft, and/or be connected to the output shaft. The fixed gears can be in engagement with the shifting gears.

Specifically, a first spur gear stage and a second spur gear stage can in each case have the fixed gear on the first transmission input shaft, and in each case have the shifting gear on the output shaft. A third spur gear stage and a fourth spur gear stage can in each case have the fixed gear on the second transmission input shaft, and in each case have the shifting gear on the output shaft. Moreover, the dual clutch transmission can have one or a plurality of coupling elements for coupling two shifting gears, wherein for example the coupling element or coupling elements can be rotatably mounted on the output shaft, or not be co-rotationally connected to the output shaft. The shifting gear of the second spur gear stage and the shifting gear of the third spur gear stage can be couplable, for example selectively couplable, to a first coupling element in such a manner that at least one winding path gear stage is able to be formed by way of the second and the third spur gear stage. The shifting gear of the second spur gear stage and the shifting gear of the third spur gear stage can be couplable, for example in conjunction with the first or the fourth spur gear stage, that is to say for example when the first or the fourth spur gear set is also fixed or co-rotationally coupled to the output shaft by further coupling elements. In other words, the shifting gear of the second spur gear stage and the shifting gear of the third spur gear stage and the first coupling element can be disposed on the output shaft in such a manner, and for example the shifting gear of the second spur gear stage and the shifting gear of the third spur gear stage can be connectable and releasable by means of the first coupling element in such a manner, that at least one winding path gear stage is able to be shifted by way of the first coupling element. The power flux of the winding path gear stage here can run over at least three spur gear stages having mutually meshing fixed gears and shifting gears. The highest gear stage and the lowest gear stage can be implemented as winding path gear stages. The dual clutch transmission can for example comprise exactly six gear stages, or for example exactly six power-shiftable gear stages.

On the output side, the output shaft can be assigned to the dual clutch transmission. The first and/or the second transmission input shaft can be brought into driving connection with the output shaft. The first and/or the second transmission input shaft can be designed as hollow shafts. The input shaft can be designed as a solid shaft. Moreover, the input shaft and/or the first and/or the second transmission input shaft can be disposed so as to be mutually coaxial and/or disposed inside one another, for example so as to be freely rotatable inside one another. Specifically, the second transmission input shaft can be disposed and/or mounted in the first transmission input shaft, for example be disposed and/or mounted so as to be freely rotatable therein. Moreover, the input shaft can be disposed and/or mounted in the second transmission input shaft, for example be disposed and/or mounted so as to be freely rotatable therein.

The dual clutch transmission can moreover comprise the first coupling element. The first coupling element can for example be designed to couple the shifting gears of the second and the third spur gear stage. For this purpose, the first coupling element can be disposed on the output shaft between the second and the third spur gear stage, and for example be mounted on the output shaft. The two shifting gears can be co-rotationally and releasably connectable to the first coupling element, wherein the two coupled shifting gears can be disposed for example so as to be rotatable on the output shaft, and/or to be idle on the latter. In this context, the two rotatably mounted shifting gears of the second and the third spur gear stage can be couplable by way of the first coupling element in such a manner that a co-rotational connection between the two shifting gears is able to be established as a function of a shifting state of the first coupling element. In other words, the two shifting gears can be connected to the first coupling element in such a manner that the first and the second transmission input shaft are placed in a dependent state. Specifically, in the case of a winding path gear stage, the shifting gear of the second spur gear stage and the shifting gear of the third spur gear stage are thus coupled to one another in order to implement a common force flux and power flux through the first and the second transmission input shaft as a result.

Specifically, according to some embodiments, the dual clutch transmission can comprise exactly two transmission input shafts, the first and the second transmission input shaft, exactly the output shaft, and exactly the first and the second shifting element. Moreover, according to some embodiments, the dual clutch transmission can comprise exactly four spur gear stages. The first spur gear stage can comprise a first fixed gear which is disposed for example at or on the first transmission input shaft, and which can engage in a first shifting gear that is disposed for example at or on the output shaft. The second spur gear stage can comprise a second fixed gear which is disposed for example at or on the first transmission input shaft, and which can engage in a second shifting gear that is disposed for example at or on the output shaft. The third spur gear stage can comprise a third fixed gear which is disposed for example at or on the second transmission input shaft, and which can engage in a third shifting gear that is disposed for example at or on the output shaft. The fourth spur gear stage can comprise a fourth fixed gear which is disposed for example at or on the second transmission input shaft, and which can engage in a fourth shifting gear that is disposed for example at or on the output shaft.

If a winding path gear stage is shifted, two of the shifting gears, that is to say for example the second and the third shifting gear, can be co-rotationally connected to one another by the first coupling element, and simultaneously the first or the fourth spur gear stage can be activated, that is to say simultaneously the first shifting gear can be connected to the output shaft by a second coupling element or the fourth shifting gear can be connected to the output shaft by a third coupling element. As a result, two gear stages can be implemented as winding path gear stages. The dual clutch transmission can thus specifically comprise six gear stages or group gear stages, which for example are power-shiftable. According to some embodiments, the dual clutch transmission can comprise four gear stages which are shiftable only via one spur gear stage and additionally two gear stages which are shiftable as winding path gear stages.

The first coupling element can be movable between a first shifting position in which the shifting gear of the second spur gear stage and the shifting gear of the third spur gear stage are coupled, and a second shifting position in which the shifting gear of the second spur gear stage and the shifting gear of the third spur gear stage are released from one another. The shifting gears can be co-rotationally and releasably connectable to the output shaft by the first and/or the second and/or the third coupling element, for example in each case one of the shifting gears can be co-rotationally and releasably connectable to the output shaft by one of the coupling elements. The coupling elements can be mounted so as to be co-rotationally and axially displaceable on the output shaft, and/or be movable, for example axially movable, by means of one or a plurality of actuating elements. The coupling elements can in each case be disposed between two shifting gears, wherein for example the fixed gears associated with the shifting gears are disposed on the same transmission input shaft, thus the first or the second transmission input shaft. The first coupling element can be disposed between the second and the third spur gear stage on or at the output shaft. The second coupling element can be disposed between the first and the second spur gear stage on or at the output shaft. The third coupling element can be disposed between the third and the fourth spur gear stage on or at the output shaft. The first and/or second and/or third coupling element can be configured in a manner known per se as dog clutches or as actuating devices, for example, shifting packs or synchronizers comprising sliding collars and synchronizer rings can be formed. In any case, the coupling elements are coupling means which are co-rotationally and axially displaceably disposed on the output shaft and by means of which the shifting gears are able to be co-rotationally connected to the output shaft for the purpose of activating a transmission ratio. The axial displacement of the coupling elements can be performed by way of the actuating element or elements. For this purpose, the drive assembly can comprise corresponding actuating elements, or for example each coupling element can comprise a respective actuating element. The shifting packs or synchronizers can comprise actuating devices or sliding collars that are axially displaceable on the output shaft but co-rotationally connected to the output shaft, and synchronizing rings that are axially directly adjacent, that is to say disposed on the right and/or left of the actuating device or the sliding collar. The actuating device, the sliding collar, or the actuating element for activating the coupling elements can be activatable manually or with power assistance. For this purpose, the drive assembly can comprise, for example, one or a plurality of actuators, so that the actuating device or the actuating element is activatable with power assistance.

The dual clutch transmission, for example one of the spur gear stages, can comprise the reverse idler gear. The reverse idler gear can be disposed, for example so as to intervene, between the first or the second transmission input shaft and the output shaft. The reverse idler gear can be disposed between a fixed gear and a shifting gear of one of the spur gear stages. As a result, in each case the fixed gear and the reverse idler gear and the shifting gear and the reverse idler gear can be in engagement and/or mesh with one another. In this context, for example, the fixed gear can engage and/or mesh only with the reverse idler gear and the shifting gear can engage and/or mesh only with the reverse idler gear. According to some embodiments, the dual clutch transmission comprises a reverse idler gear, as a result of which a reverse gear, for example a reverse gear in the form of a winding path gear, can be implemented. As a result, a more compact installation space can advantageously be implemented. The dual clutch transmission moreover has an improved transmission spread.

In a design embodiment of the disclosure, each of the spur gear stages of the dual clutch transmission comprises a fixed gear and a shifting gear. The fixed gears can be disposed, for example co-rotationally, on the first and second transmission input shaft, and/or can be connected to the transmission input shafts. The shifting gears can be disposed and/or mounted, for example rotatably disposed and/or rotatably mounted, on the output shaft. One of the spur gear stages comprises the reverse idler gear between the fixed gear and the shifting gear.

In a design embodiment of the disclosure, the first spur gear stage and the second spur gear stage each have the fixed gear on the first transmission input shaft, and each have the shifting gear on the output shaft, and the third spur gear stage and the fourth spur gear sage each have the fixed gear on the second transmission input shaft, and each have the shifting gear on the output shaft.

Specifically, the first or the second or the third or the fourth spur gear stage can comprise the reverse idler gear, and/or the reverse idler gear can be disposed in them. Specifically, the reverse idler gear can be disposed in the first or the fourth spur gear stage, for example between the fixed gear and the shifting gear of the first or the fourth spur gear stage. As a result, it is advantageously possible to implement four forward gears (of which one is a winding path gear) and two reverse gears (of which one is a winding path gear) with the dual clutch transmission. Alternatively, the reverse idler gear can be disposed in the second or the third spur gear stage, for example between the fixed gear and the shifting gear of the second or the third spur gear stage. As a result, it is advantageously possible to implement three forward gears as single-stage gears and three reverse gears, of which two are winding path gears, with the dual clutch transmission.

The disclosure furthermore relates to a drive assembly, for example a continuously variable transmission with an electrically variable path as an input-coupled structure, for a working machine, having a dual clutch transmission, for example having a dual clutch transmission according to at least one of the embodiments disclosed herein. The drive assembly has the above-mentioned advantages of the dual clutch transmission.

In a design embodiment of the disclosure, the drive assembly comprises a transmission device. The dual clutch transmission is disposed in the power flux downstream of the transmission device. The dual clutch transmission can on the input side be connectable, or connected, to the first output side of the transmission device. The third input side of the dual clutch transmission can be connectable, or connected, for example directly or indirectly to a first output side of the transmission device.

In a design embodiment of the disclosure, the transmission device comprises a range transmission, for example a single-stage transmission or a multi-stage transmission, or a continuously variable transmission. Specifically, the transmission device can be designed as a range transmission, for example as a single-stage transmission or as a multi-stage transmission, or as a continuously variable transmission. The multi-stage transmission can for example be shiftable, for example fully power-shiftable, in a plurality of powershift ratio stages. The multi-stage transmission can comprise one or a plurality of planetary gearboxes.

In a design embodiment of the disclosure, the transmission device comprises a first and second input side and a first output side, and the dual-clutch transmission is connectable or connected, for example on the input side, to the first output side of the transmission device, and the drive assembly comprises an input shaft and a first and a second energy machine, wherein the first energy machine is connectable or connected to the input shaft and the second energy machine is connectable or connected to the second input side.

The drive assembly can thus comprise:
a transmission device having a first and second input side and a first output side, for example having a first and a second input and a first output,
and the dual clutch transmission, for example having more than one stage, wherein at least one gear is embodied as a winding path gear, and the dual clutch transmission, for example on the input side, is connectable or connected to the first output side of the transmission device,
and an input shaft, wherein for example the first input side can be connectable or connected to the input shaft,
and an output shaft,
and a first energy machine, wherein the first energy machine is connectable or connected to the input shaft,
and a second energy machine, wherein the second energy machine is connectable or connected to the second input side.

By way of the drive assembly, a rotating speed and/or a direction of rotation, and/or for example a rotation, of the first output side of the transmission device can be settable and/or adjustable and/or actuatable, for example a rotating speed and/or a direction of rotation, and/or for example a rotation, of the first output side of the transmission device can be settable and/or adjustable and/or actuatable by way of the second energy machine. In other words, a rotating speed and/or a direction of rotation, and/or for example a rotation, of the second energy machine can be settable and/or adjustable and/or actuatable, for example in such a manner that a rotating speed and/or a direction of rotation, and/or for example a rotation, of the first output side of the transmission device is settable and/or adjustable and/or actuatable. Alternatively or additionally, the drive assembly and/or the working machine can comprise a control unit. The control unit can be configured to set and/or adjust and/or actuate a rotating speed and/or a direction of rotation, and/or for example a rotation, of the first output side of the transmission device, for example to set and/or adjust and/or actuate a rotating speed and/or a direction of rotation, and/or for example a rotation, of the first output side of the transmission device by way of the second energy machine. Specifically, the control unit can be specified to set and/or adjust and/or actuate a rotating speed and/or a direction of rotation, and/or for example a rotation, of the second energy machine, so as to set and/or adjust and/or actuate a rotating speed and/or a direction of rotation, and/or for example a rotation, of the first output side of the transmission device.

An input side, for example the first and/or the second input side, can be a mechanical interface by way of which a force and/or a torque and/or a rotating speed can be directed into the drive assembly, for example the transmission device and/or the dual clutch transmission. An output side, for example the first and/or the second output side and/or the output shaft, can be a mechanical interface by way of which a force and/or a torque and/or a rotating speed can be directed out of the drive assembly, for example the transmission device and/or the dual clutch transmission.

The first input side can comprise a first drive element, or be configured as a first drive element. The second input side can comprise a second drive element, or be configured as a second drive element. The first and/or the second input side, for example the first and/or the second drive element, can be configured as a shaft, for example, and/or comprise the latter. The first output side can comprise a first drive output element, or be configured as a first drive output element. The first output side, for example the first drive output element, can be configured as a shaft, for example, and/or comprise the latter.

The first and/or the second energy machine can be implemented in a layshaft construction mode or in an in-line construction mode, for example be disposed as the layshaft construction mode or as the in-line construction mode in the drive assembly. The first and/or the second energy machine can be designed as electric motors, for example as a first and a second electric motor. Alternatively or additionally, the first and/or the second energy machine can be designed as a fuel cell, for example as a first and a second fuel cell, or comprise the latter. However, the first and/or the second energy machine can also be a permanent-magnet-excited and/or electrically excited synchronous and/or asynchronous machine that is operated using direct current and/or three-phase current, for example a permanent-magnet three-phase synchronous machine. The first and the second energy machine can be operable as motors and/or as generators. The first and the second energy machine can drive the drive assembly by way of a rotating speed and/or a force and/or a torque. The first energy machine, for example the first electric motor, can comprise a first drive shaft. The second energy machine, for example the second electric motor, can comprise a second drive shaft. The first and the second energy machine can be operable at each operating point, one as a motor and the other as a generator. The control unit can be configured to operate the first and the second energy machine at each operating point, one as a motor and the other as a generator. The control unit can be configured to set and/or adjust and/or actuate the first and the second energy machine at each operating point, for example in such a way that one is operated as a motor and the other is operated as a generator.

The first energy machine can be connected on the output side to the input shaft. For this purpose, a rotor of the first energy machine, for example an internal rotor, can be connected to the input shaft, for example. The first energy machine can be embodied as a torque motor. In this embodiment, the first energy machine directly drives the input shaft. Likewise, the first energy machine can also be connected directly or by way of one, or by one, or through one first transmission stage, for example a spur gear stage or a gearwheel pair or a planetary set, or a transmission and/or a shaft, to the input shaft. The first energy machine can thus be connected to the input shaft by way of a fixed transmission ratio or by way of a variable transmission ratio. The first energy machine can also be designed as a generator and can charge an energy store, for example in a recuperative mode.

The second energy machine can be connected on the output side to the second input side of the transmission device. For this purpose, a rotor of the second energy machine, for example an internal rotor, can be connected to the second input side, for example. The second energy machine can be embodied as a torque motor. Likewise, the second energy machine can also be connected directly or by way of one, or by one, or through one second transmission stage, for example a spur gear stage or a gearwheel pair or a planetary set, or a transmission and/or a shaft, to the second input side. The second energy machine can thus be connected to the second input side by way of a fixed transmission ratio or by way of a variable transmission ratio, for example by way of the transmission. The second energy machine can also be designed as a generator and can charge the energy store, for example in a recuperative mode.

The drive assembly, for example the working machine, can comprise one or a plurality of energy stores. The energy store can be electrically connected and/or electrically couplable to the first and/or the second energy machine. The energy store can be an electrical energy store. The energy store can supply the first and/or the second energy machine with energy, for example electrical energy, and/or power, for example electrical power. The energy store can be charged by the first and/or the second energy machine, for example with energy, for example electrical energy, and/or power, for example electrical power. The energy store can be designed as a battery and/or a rechargeable battery and/or a supercapacitor and/or a fuel cell and/or any other device for storing electrical energy.

The drive assembly can comprise a start-up module for electrical starting up. The start-up module for electrical starting up can be designed to selectively couple and decouple a drive connection between the input shaft and/or the first and/or the second energy machine and/or a drive unit, on the one hand, and the transmission device, on the other hand. The start-up module can have a further shifting element which for driving can be connected on the drive side to the input shaft and/or the first and/or the second energy machine and/or the drive unit, and on the output side is connected to the transmission device, for example by way of a shaft. The start-up module can be disposed in the power flux between the first energy machine and the transmission device, or can be disposed in the power flux between the first energy machine and a module for reversing the direction of rotation, or can be disposed in the power flux between the module for reversing the direction of rotation and the transmission device, or can be disposed in the power flux between the first energy machine and the transmission device. The start-up module for electrical starting up can be designed to selectively couple and decouple a drive connection between:
the first energy machine and the transmission device, or
the first energy machine and the module for reversing the direction of rotation, or
the module for reversing the direction of rotation and the transmission device, or
the first energy machine and the transmission device.

The further shifting element can be connectable or connected, on the drive side and the output side, to the above-mentioned functional groups, for example by way of shafts.

According to some embodiments, a rotating speed and/or a direction of rotation, and/or for example a rotation, of the first output side of the transmission device are/is able to be set and/or adjusted and/or actuated. As a result, a battery-powered electric range of travel can advantageously be implemented. Moreover, a more compact installation space is advantageously made possible. Moreover, the drive assembly has significantly more gears and thus provides a greater transmission spread. Furthermore, the drive assembly can advantageously be implemented as a power-shiftable seamless continuously variable transmission with an electrically variable path, wherein the gear change can take place at identical rotating speeds of all components involved (so-called seamless shifts).

In a design embodiment of the disclosure, the drive assembly comprises a drive unit. The drive unit is connected to the input shaft. Alternatively, the dual clutch transmission can comprise the drive unit and the input shaft. The input shaft can be connectable, or connected, to the first input side. The drive unit and/or the first energy machine can be connectable, or connected, to the first input side of the transmission device by way of the, or through the, input shaft. The drive unit can be designed as an internal combustion engine. Alternatively or additionally, the drive unit can be an electric motor. The first energy machine and the drive unit can be at a constant rotating speed ratio. The second energy machine and the drive unit can be at a constant torque ratio.

With this configuration of the drive assembly, a rotating speed and/or a direction of rotation, and/or for example a rotation, of the drive unit and/or input shaft in or with the transmission device can be superimposed in such a way that a rotating speed and/or a direction of rotation, and/or for example a rotation, of the first output side of the transmission device is settable and/or adjustable and/or actuatable, for example settable and/or adjustable counter to the rotating speed and/or direction of rotation, and/or for example rotation, of the drive unit and/or input shaft, for example the direction of rotation of the first output side is settable and/or adjustable counter to the direction of rotation of the drive unit and/or input shaft. In other words, the rotating speed and/or direction of rotation, and/or for example rotation, of the drive unit and/or input shaft can be superimposed in or with the transmission device with the rotating speed and/or direction of rotation, and/or for example rotation, of the second energy machine, for example in such a manner that a rotating speed and/or a direction of rotation, and/or for example a rotation, of the first output side of the transmission device is settable and/or adjustable and/or actuatable, for example settable and/or adjustable counter to the rotating speed and/or direction of rotation, and/or for example rotation, of the drive unit and/or input shaft, for example the direction of rotation of the first output side is settable and/or adjustable counter to the direction of rotation of the drive unit and/or input shaft. Specifically, the rotating speed and/or direction of rotation, and/or for example rotation, of the second energy machine can be settable and/or adjustable and/or actuatable in such a manner, and can be able to be superimposed in or with the transmission device with the rotating speed and/or direction of rotation, and/or for example rotation, of the drive unit and/or input shaft in such a manner, that a rotating speed and/or a direction of rotation, and/or for example a rotation, of the first output side of the transmission device is settable and/or adjustable and/or actuatable, for example settable and/or adjustable counter to the rotating speed and/or direction of rotation, and/or for example rotation, of the drive unit and/or input shaft, for example the direction of rotation of the first output side is settable and/or adjustable counter to the direction of rotation of the drive unit and/or input shaft. As a result, reverse operation of the drive assembly and/or reverse travel of the working machine can be made possible. Alternatively or additionally, the control unit can be configured to superimpose a rotating speed and/or a direction of rotation, and/or for example a rotation, of the drive unit and/or input shaft in or with the transmission device, and to set and/or adjust and/or actuate a rotating speed and/or a direction of rotation, and/or for example a rotation, of the first output side of the transmission device, for example to set and/or adjust counter to the rotating speed and/or direction of rotation, and/or for example rotation, of the drive unit and/or input shaft, for example to set and/or adjust the direction of rotation of the first output side counter to the direction of rotation of the drive unit and/or input shaft. In other words, alternatively or additionally, the control unit can be configured to superimpose the rotating speed and/or direction of rotation, and/or for example rotation, of the drive unit and/or input shaft in or with the transmission device with the rotating speed and/or direction of rotation, and/or for example rotation, of the second energy machine, and to set and/or adjust and/or actuate a rotating speed and/or a direction of rotation, and/or for example a rotation, of the first output side of the transmission device, for example to set and/or adjust counter to the rotating speed and/or direction of rotation, and/or for example rotation, of the drive unit and/or input shaft, for example to set and/or adjust the direction of rotation of the first output side counter to the direction of rotation of the drive unit and/or input shaft. Specifically, alternatively or additionally, the control unit can be configured to set and/or adjust and/or actuate the rotating speed and/or direction of rotation, and/or for example rotation, of the second energy machine and to superimpose the rotating speed and/or direction of rotation, and/or for example rotation, of the second energy machine in or with the transmission device at the rotating speed and/or direction of rotation, and/or for example rotation, of the drive unit and/or input shaft in order to set and/or adjust and/or actuate a rotating speed and/or a direction of rotation, and/or for example a rotation, of the first output side of the transmission device, for example to set and/or adjust counter to the rotating speed and/or direction of rotation, and/or for example rotation, of the drive unit and/or input shaft, for example to set and/or adjust the direction of rotation of the first output side counter to the direction of rotation of the drive unit and/or input shaft. As a result, reverse operation of the drive assembly and/or reverse travel of the working machine can be made possible.

According to some embodiments, a setting and/or adjustment, and/or for example a reversal, of the direction of rotation of the first output side of the transmission device can be implemented by combining the drive unit with the transmission device and the dual clutch transmission. The drive assembly can thus be implemented as a power-shiftable continuously variable transmission with an electrically variable path. Advantageously, the power to be installed of the first and the second energy machine can be reduced. Moreover, the required installation space can be reduced. It is thereby advantageously possible to achieve a construction of the drive assembly that is simple in design and compact. As a result, the drive assembly, for example also the working machine, can be able to be driven advantageously in a hybrid manner.

In a design embodiment of the disclosure, the transmission device is designed as an epicyclic transmission stage. The transmission device can be embodied as a mechanical epicyclic transmission stage, for example an electrically power-branched epicyclic transmission stage. The transmission device, for example the epicyclic transmission stage, can comprise a planetary gear, for example a first planetary gear, and/or a reduced planetary gear, for example a first reduced planetary gear, and/or can be embodied as a planetary gear, for example the first planetary gear, and/or reduced planetary gear, for example the first planetary gear. The transmission device, for example the epicyclic transmission stage, for example the planetary gear, for example the first planetary gear, and/or the reduced planetary gear, for example the first planetary gear, can have a total of four mechanical interfaces, for example the input and output sides, for example the inputs and outputs. Specifically, the total of four mechanical interfaces, for example the input and output sides, for example the inputs and outputs, can have four shafts leading to the outside.

The first input side of the transmission device, for example of the epicyclic transmission stage, for example of the first planetary gear, can be connected to the input shaft. The first input side of the transmission device, for example of the epicyclic transmission stage, for example of the first planetary gear, can be a first ring gear of the first planetary gear. Alternatively or additionally, the first input side of the transmission device can be connected to the first ring gear of the first planetary gear. The first ring gear can be connected to the input shaft. The first ring gear can be connected to the input shaft by way of a, or by a, first shaft.

The second input side of the transmission device, for example of the epicyclic transmission stage, for example of the first planetary gear, can be connected to the second energy machine. The second input side of the transmission device, for example of the epicyclic transmission stage, for example of the first planetary gear, can be a first sun of the first planetary gear. Alternatively or additionally, the second input side of the transmission device can be connected to the first sun of the first planetary gear. The first sun can be connected to the second energy machine. The first sun can be connected by way of, or by, a second shaft and/or the second transmission stage to the second energy machine.

The first output side of the transmission device, for example of the epicyclic transmission stage, for example of the first planetary gear, can be connected to the dual clutch transmission, for example to the third input side of the dual clutch transmission, for example to an input side of the first and the second shifting element. The first output side of the transmission device, for example of the epicyclic transmission stage, for example of the first planetary gear, can be a first planet carrier of the first planetary gear. Alternatively or additionally, the first output side can be connected to the first planet carrier of the first planetary gear. The first planet carrier can be connected to the dual clutch transmission, for example to the third input side of the dual clutch transmission, for example to an input side of the first and the second shifting element. The first planet carrier can be connected to the dual clutch transmission, for example to the third input side of the dual clutch transmission, for example to an input side of the first and the second shifting element, through a, or by a, third shaft.

Alternatively, the transmission device, for example the epicyclic transmission stage, for example the first planetary gear, can comprise a first and a second sun and a first and a second planetary set and a first planet carrier. The first and the second planetary set can be disposed on the first planet carrier. The first sun and the first planetary set can engage in one another and/or mesh with one another. The second sun and the second planetary set can engage in one another and/or mesh with one another. In this alternative embodiment, the first input side of the transmission device, for example of the epicyclic transmission stage, for example of the first planetary gear, can be the first sun of the first planetary gear. Additionally or alternatively, the first input side can be connected to the first sun of the first planetary gear. The first sun can be connected to the input shaft. The first sun can be connected to the input shaft through, or by, the first shaft. The second input side of the transmission device, for example of the epicyclic transmission stage, for example of the first planetary gear, can be a second sun of the first planetary gear. Alternatively or additionally, the second input side can be connected to the second sun of the first planetary gear. The second sun can be connected to the second energy machine. The second sun can be connected to the second energy machine through, or by, the second shaft and/or the second transmission stage. The first output side of the transmission device, for example of the epicyclic gear stage, for example of the first planetary gear, can be the first planet carrier of the first planetary gear. Alternatively or additionally, the first output side can be connected to the first planet carrier of the first planetary gear. The first planet carrier can be connected to the dual clutch transmission, for example to the third input side of the dual clutch transmission. The first planet carrier can be connected to the dual clutch transmission, for example to the third input side of the dual clutch transmission through, or by, a third shaft.

The dual clutch transmission can be connected on the input side to the first output side, for example the first ring gear or the first planet carrier or a sun, for example the third sun, of the second planetary gear, for example by way of a shaft. According to some embodiments, by combining the dual clutch transmission with the epicyclic transmission stage as part of a variable speed gear with a first output side, that is to say only one output, the required installation space can be reduced. It is thereby advantageously possible to achieve a construction of the drive assembly that is simple in design and compact. Otherwise, the drive assembly has the advantages mentioned above.

In a design embodiment of the disclosure, the drive assembly comprises a set of power electronics, wherein for example electrical power and/or electrical energy is transmissible between the first and/or the second energy machine and/or the energy store by way of the set of power electronics. The set of power electronics can be configured to set and/or adjust and/or actuate the first and the second energy machine and/or the energy store. Specifically, the set of power electronics can be configured to transmit electrical power and/or electrical energy between the first and/or the second energy machine and/or the energy store. The electrical power and/or electrical energy can be transmissible from the first energy machine to the second energy machine and/or to the energy store, and vice versa. The set of power electronics can comprise an electronic control apparatus and/or an inverter and/or a voltage transformer. During operation, the inverter can convert the voltage and/or energy and/or power of the energy store into a voltage and/or energy and/or power required by the energy machines. This procedure can be reversed for the purposes of charging the energy store. The electronic control apparatus can comprise a computing unit, a computer, a processor, a memory and/or all of the software, hardware, algorithms, connections, and for example also sensors, which are required for setting and/or adjusting the energy machine. The energy store can be actuatable by the electronic control apparatus, alternatively the control unit, in order to store electrical energy and/or power and/or to deliver the latter to the energy machines. The electronic control apparatus, alternatively the control unit, and/or the energy machines can be electrically connected, and/or electrically couplable, to the set of power electronics and/or the energy store. Alternatively, the control unit can be designed as an electronic control apparatus or comprise the latter and/or assume the tasks of the electronic control apparatus. The control unit and/or the electronic control apparatus can be configured to set and/or adjust the first and/or the second energy machine and/or the energy store in such a way that the electrical energy or power generated by the first and/or the second energy machine and/or stored in the energy store is discharged.

In a design embodiment of the disclosure, a decoupler is disposed between the drive unit and the transmission device, or between the drive unit and the first energy machine, or between the drive unit and the dual clutch transmission. By using the decoupler between the drive unit and the transmission device or the first energy machine, or between the drive unit and the dual clutch transmission, the drive unit can be decoupled from the drive assembly or the dual clutch transmission. As a result, the drive assembly can advantageously be operated in a battery-powered electric driving range, that is to say for example a hybrid drive of the drive assembly can be implemented.

In a design embodiment of the disclosure, the drive assembly comprises a control unit, wherein the drive assembly is able to be operated by the control unit. Alternatively or additionally, the working machine comprises the control unit, wherein the working machine and/or the drive assembly can be operated with the control unit. In other words, the control unit is configured to operate the working machine and/or the drive assembly, for example the drive unit. The control unit can be signal-connected and/or operatively coupled and/or signal-transmittingly and/or data-conductingly connected to the first and/or the second energy machine and/or the drive unit. The control unit can be configured to receive one or more rotating speed signals and/or torque signals from the drive assembly, for example from rotating speed and/or torque sensors of the drive assembly, and/or from the first and/or the second energy machine and/or the drive unit. The control unit can be configured to determine a rotating speed and/or a torque by means of the rotating speed signal and/or the torque signal. The control unit can be configured to set and/or adjust the rotating speed and/or the torque of the drive assembly, for example of the first and/or the second energy machine and/or the drive unit, for example to set and/or adjust a specifiable rotating speed and/or a specifiable torque. Further embodiments of the control unit are described above and below.

In a design embodiment of the disclosure, the input shaft is connected to a first power output. The drive unit and/or the first energy machine can be connected to the input shaft. The drive unit and/or the first energy machine can be connectable or connected to the first power output by way of, or through, the input shaft. The first power output can comprise a PTO unit, or be designed as a PTO unit. The PTO unit can comprise a PTO transmission and/or a PTO shaft. The drive unit and/or the first energy machine can, for example by way of the input shaft, be connectable or connected to the first power output, for example to the PTO unit, for example to the PTO transmission and/or the PTO shaft. The first power output, for example the PTO unit, for example the PTO transmission and/or the PTO shaft, are/is able to be driven by the drive unit and/or the first energy machine. The control unit can be configured to set and/or adjust the rotating speed of the first power output.

The drive assembly can comprise one or a plurality of conduits, for example one or a plurality of central conduits, for the input shaft. The conduit or the conduits, for example the central conduit or conduits, can be configured as one or a plurality of shaft leadthroughs, for example one or a plurality of central shaft leadthroughs, for the input shaft.

The transmission device and/or the dual clutch transmission and/or the start-up module and/or the module for the reversal of the direction of rotation can thus have one or a plurality of shaft leadthroughs, for example one or a plurality of central shaft leadthroughs, for the input shaft. Specifically:
the first and/or the second and/or the third and/or the fourth and/or the fifth and/or each additional shifting element and/or the first and the second transmission input shaft, and/or
the transmission device, for example the epicyclic transmission stage, for example the first reduced planetary gear, for example the suns thereof, and/or
the first and/or the second transmission stage, and/or the additional shafts
of the clutch device and/or the decoupler,
can have in each case conduits, for example shaft leadthroughs, for the input shaft. As a result, a compact and/or modular and/or structurally simple design embodiment of the drive assembly, for example of the first power output, can advantageously be achieved.

The disclosure furthermore relates to a working machine comprising a dual clutch transmission, for example a dual clutch transmission according to one or more of the embodiments disclosed herein, or a drive assembly, for example a drive assembly according to one or more of the embodiments disclosed herein.

The working machine can be a construction machine or a towing vehicle, for example an agricultural towing vehicle, for example a tractor or hauler. The working machine has the above-described advantages of the drive assembly. The working machine comprises the drive assembly. The drive assembly is designed to drive the working machine. The working machine can comprise one, two or a plurality of axle(s). The working machine can be drivable by a rotating speed and/or force and/or a torque of the drive unit.

The control unit can be specified for controlling, by open-loop and/or closed-loop control, for example for setting and/or adjusting, the working machine, for example the drive unit. The working machine can comprise an input and output unit. The control unit can be connected to the input and output unit for signalling, and/or be operatively coupled and/or connected thereto for transmitting signals and/or transmitting data, and/or can be able to be actuated and/or set and/or adjusted by the input and output unit. The input and output unit can be integrated into the control unit, or vice versa. The operator of the working machine can use the input and output unit to set and/or adjust a speed of the working machine, for example. The control unit can be configured to set and/or adjust the first and/or the second energy machine and/or the stator, for example in such a manner that those are electrically impinged.

The working machine can moreover comprise one or more auxiliary units, for example a pump and/or a radiator, etc. The auxiliary units can be a constituent part of the hydraulic system of the drive assembly. The working machine can comprise the first power output, for example the PTO unit. The control unit can be configured to set and/or adjust and/or actuate the drive assembly and/or the working machine by means of a driving signal and to set and/or adjust, for example to increase or reduce, a speed of the working machine by means of and/or based on the driving signal. The working machine can comprise the one or several ground-engaging means. The ground-engaging means can support and/or carry the working machine on the ground. A towing vehicle frame of the working machine can be supported on the ground-engaging means. The ground-engaging means can be wheels or tracks or chains. For example, the ground-engaging means can be front wheels and rear wheels. The working machine can comprise a speed sensor, for example a rotating speed sensor, for detecting a speed of the working machine. Specifically, the control unit can be configured to set and/or adjust and/or actuate a force and/or a torque and/or a rotating speed of the drive unit and/or of the first and/or the second energy machine using the driving signal or a plurality of driving signals.

The shifting elements, for example their valves or valve assemblies or actuators, and/or the drive unit and/or the first power output, for example the PTO unit, and/or the first and/or the second energy machine, and/or the energy store and/or the set of power electronics can be able to be actuated and/or set and/or adjusted, for example able to be controlled in an open loop and/or closed loop, by the control unit. The control unit can send and/or receive signals to control the operation of the drive assembly and/or of the working machine. The signals can be expediently provided via a suitable data communication network, for example one that conforms to the ISOBUS and/or CAN standard. The control unit can be designed as an electronic module, an embedded system, a computing unit, a computer, or as a module for controlling in an open and/or closed loop the drive assembly and/or the working machine. The control unit can comprise one or a plurality of processors, a memory and/or all of the software, hardware, algorithms, connections, and for example also sensors, that are required for the open-loop and/or closed-loop control of the drive assembly and/or the working machine. Methods can take the form of a program or algorithm, which methods are able to be executed on and/or by the control unit. The control unit can comprise any apparatus that analyses data from various sensors, can compare data, and can make the decisions necessary to control in an open loop and/or a closed loop and/or to carry out the operation of the drive assembly and/or the working machine, and the necessary tasks for controlling in an open loop and/or closed loop the operation of the drive assembly and/or the working machine. The control unit can be connected for signalling and/or operatively coupled and/or connected for transmitting signals and/or transmitting data to the components of the drive assembly and/or the working machine, thus for example to the shifting elements, for example their valves or valve devices or actuators, and/or the drive unit and/or the first power output, for example the PTO unit, and/or the first and/or the second energy machine and/or the energy store and/or the set of power electronics and/or the sensors. Connected for signalling and/or operatively coupled and/or connected for transmitting signals and/or transmitting data can be presently understood to mean, inter alia, that signals and/or data can be exchanged between the connected components and the control unit. Signals can, for example, be received and sent, and/or processed and/or manipulated, by the control unit. The connection between the control unit as well as the parts or components of the drive assembly and/or the working machine can be implemented by wire, i.e. for example by means of cables, and/or in a wireless manner, i.e. by radio, for example by means of Bluetooth or WLAN. The connection between the control unit and the parts or components of the drive assembly and/or the working machine can be implemented by a local area network (LAN), a radio access network (RAN), a metropolitan area network (MAN), a wide area network (WAN), Worldwide Interoperability for Microwave Access (WIMAX), or a wireless local area network (WLAN). Communication can take place, for example, by means of Isobus, CAN bus, or similar. The control unit can be connected directly to the input and output unit, for example to the input and output unit which is disposed in a cab of the working machine and by means of which data entered by an operator can be transmitted to the control unit, or data can be received from the control unit and output to the latter. The control unit can be integrated into the input and output unit, or vice versa.

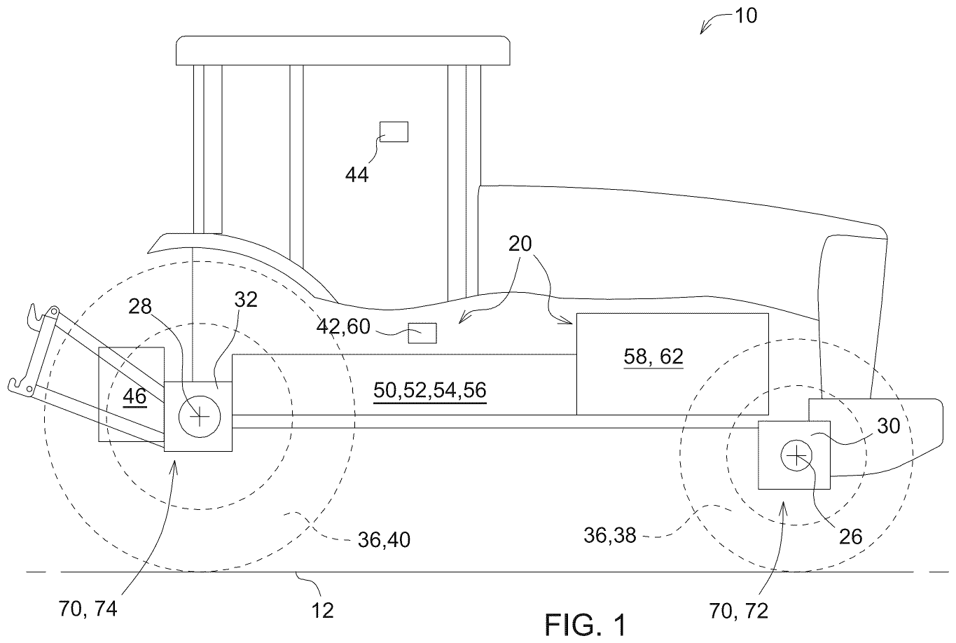

FIG. 1 shows a schematic illustration of a first example embodiment of a working machine 10 according to the disclosure, presently of an agricultural towing vehicle or tractor, having a drive assembly 20 according to the disclosure and a dual clutch transmission 52 according to the disclosure. The working machine 10 is able to be driven by the drive assembly 20 and/or the dual clutch transmission 52. The drive assembly 20 can comprise the dual clutch transmission 52, wherein at least one gear of the dual clutch transmission is embodied as a winding path gear, or a transmission device 50 and the dual clutch transmission 52 disposed in the power flux downstream of the transmission device 50. The drive assembly 20 can furthermore comprise a first and a second energy machine 54, 56. The dual clutch transmission 52 and/or the drive assembly 20 can comprise an input shaft 86. The dual clutch transmission 52 and/or the drive assembly 20 can comprise an output shaft 88.

The working machine 10, or for example the drive assembly 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The working machine 10 can have one or a plurality of ground-engaging means 36, presently illustrated in the form of wheels 38, 40, which engage with a ground 12 in order to transmit drive forces and/or by way of which the working machine 10 is supported on the ground 12. The working machine 10, for example the drive assembly 20, can comprise a propulsion drive 70, for example a front-axle drive 72 and a rear-axle drive 74. The propulsion drive 70 can comprise the first vehicle axle 26 and/or the second vehicle axle 28 and/or a first differential 30 and/or a second differential 32 and/or the one or several ground-engaging means 36. The front-axle drive 72 can comprise the first vehicle axle 26 and/or the first differential 30, thus for example a front-axle differential, and/or the one or several ground-engaging means 36. The rear-axle drive 74 can comprise the second vehicle axle 28 and/or the second differential 32, thus for example a rear-axle differential, and/or the one or several ground-engaging means 36. The first vehicle axle 26 can be connected to the first differential 30. The second vehicle axle 28 can be connected to the second differential 32.

The output shaft 88 can be connected to the propulsion drive 76, for example to the first and/or the second differential 30, 32, for example only to the second differential 32. The output shaft 88 can be connected to the second vehicle axle 28 by way of the second, or by the second, differential 32. A force and/or a torque and/or a rotating speed can be transmissible from the drive output 54 to the first and/or the second vehicle axle 26, 28, and thus for example to the ground-engaging means 36, by way of the first, or by the first, differential 30 and/or by way of the second, or by the second, differential 32. The drive assembly 20 or the working machine 10 can comprise a drive unit 58. The drive unit 58 can be connectable, or connected, to the input shaft 86. With the drive assembly 20, for example the drive unit 58, a rotating movement and/or force and/or a torque and/or a rotating speed can be generatable and can be transmissible, for example by way of the transmission device 50 and the dual clutch transmission 52, to the output shaft 88 and to the first and/or the second vehicle axle 26, 28. The first and/or the second vehicle axle 26, 28 convert the rotating movement and/or force and/or the torque and/or the rotating speed into a rotating movement and/or force and/or a torque and/or rotating speed of one or a plurality of ground-engaging means 36, and thus into thrust of the working machine 10. The working machine 10 can moreover comprise a towing vehicle frame. The towing vehicle frame can for example be supported by the ground-engaging means 36, for example the wheels 38, 40, which are suspended on the first and/or the second vehicle axle 28, 30. Specifically, a first pair of wheels 38 are disposed on the first vehicle axle 26, and a second pair of wheels 40 are disposed on the second vehicle axle 28. Here, the diameters of the wheels 38, 40 may differ; for example, the diameter of the first pair of wheels 38 may be smaller than the diameter of the second pair of wheels 40. Alternatively, the ground-engaging means 36 can also be designed and disposed as tracks or chains.

The working machine 10, or for example the drive assembly 20 or the dual clutch transmission 52, can comprise a first power output 46. The first power output 46 can comprise a PTO unit 108. The first power output 46 can be provided for driving an implement (not shown) which is able to be attached to the working machine 10 by way of an interface (e.g. three-point interface). The working machine 10, for example alternatively or additionally the dual clutch transmission 52 or the drive assembly 20, can comprise a control unit 42 and/or an input and output unit 44. The control unit 42 can be connected to the input and output unit 44 for signalling, and/or be operatively coupled thereto and/or connected thereto for transmitting signals and/or transmitting data. Specifically, the control unit 42 can be connected directly to the input and output unit 44 which is disposed in a cab of the working machine 10, and by way of which data entered by an operator can be transmitted to the control unit 42 or received and output by the latter. The drive assembly 20, and/or for example the working machine 10 and/or the dual clutch transmission 52, can be settable and/or adjustable by the control unit 42. The control unit 42 can be connected to the drive unit 58 and/or the first and/or the second energy machine 54, 56 for signalling, and/or be operatively coupled thereto and/or connected thereto for transmitting signals and/or transmitting data.

The control unit 42 can be configured to set and/or adjust the speed and/or the torque and/or the force of the dual clutch transmission 52 and/or of the drive assembly 20, for example of the drive unit 58 and/or the first and/or the second energy machine 54, 56, for example to actuate and/or control them in an open loop and/or closed loop. The control unit 42 can be configured to set and/or adjust a predeterminable rotating speed and/or a predeterminable torque and/or a predeterminable force of the dual clutch transmission 52 and/or the drive assembly 20, for example of the drive unit 58 and/or of the first and/or the second energy machine 54, 56, for example to actuate and/or control them in an open loop and/or closed loop. The control unit 42 can be configured to set and/or adjust the drive assembly 20, for example alternatively or additionally the working machine 10, in order to set and/or to adjust, for example to control in an open loop and/or closed loop, the rotating speed and/or the torque and/or the force of the drive unit 58.

Moreover, the working machine 10, alternatively or additionally the drive assembly 20, can comprise a set of power electronics 60 in order to transmit the electrical power or energy between the first and/or the second energy machine 54, 56 and an energy store 62, presently a battery (accumulator), for example. The control unit 42 can be connected to the set of power electronics 60 and to the energy store 62 for signalling, and/or be operatively coupled thereto and/or connected thereto for transmitting signals and/or transmitting data. The energy store 62 can supply the electrically driven components of the drive assembly 20 with currents or voltages of suitable frequency and amplitudes in order to provide desired output rotating speeds or torques for the first power output 46 and/or the drive assembly 20.

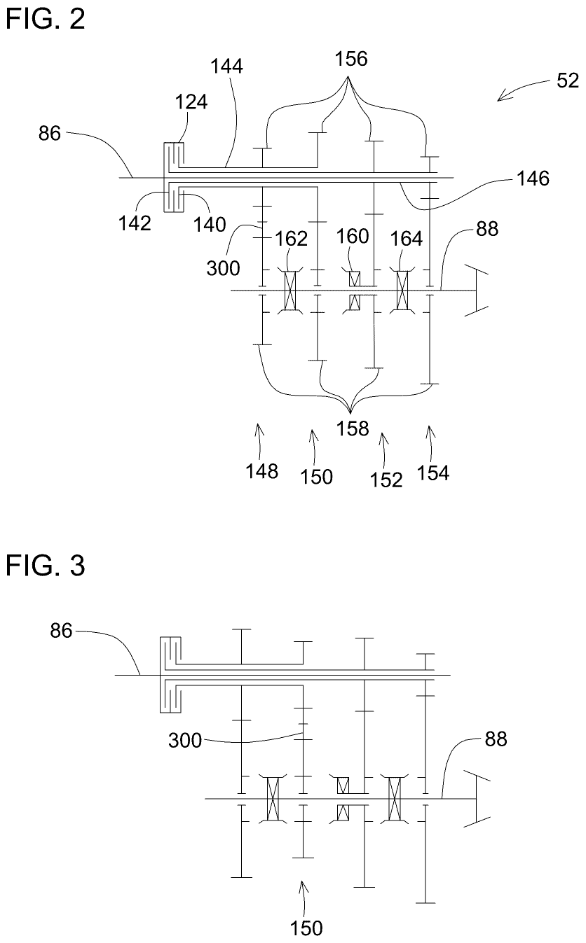

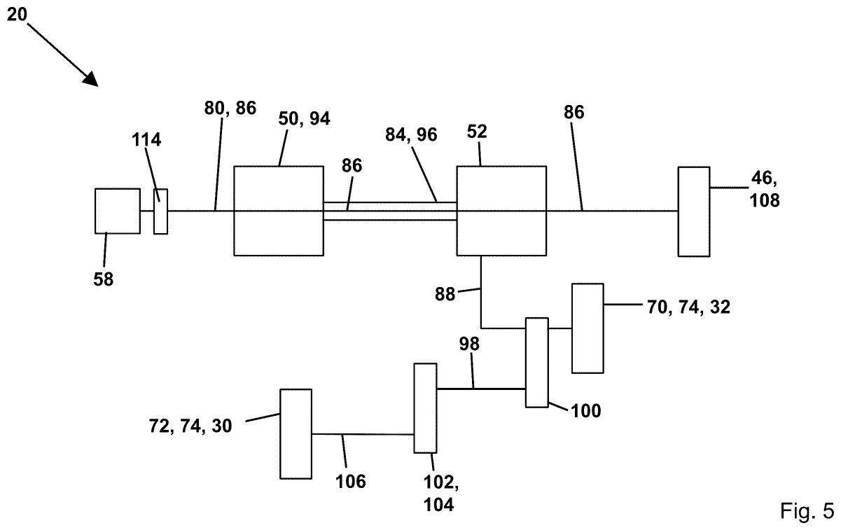

FIG. 2 shows a schematic illustration of a first example embodiment of the dual clutch transmission 52 according to the disclosure. The dual clutch transmission 52 shown in FIG. 2 corresponds substantially to the dual clutch transmission 52 shown in FIG. 1, so that only details and/or points of differentiation will be discussed hereunder. The working machine 10 and/or the drive assembly 20 illustrated in FIG. 1 can comprise the dual clutch transmission 52 illustrated in FIG. 2. The drive assembly 20 illustrated in FIGS. 4 to 11 can comprise the dual clutch transmission 52 illustrated in FIG. 2. The dual clutch transmission 52 comprises a first and a second shifting element 140, 142. The first shifting element 140 is connected to a first transmission input shaft 144, and the second shifting element 142 is connected to a second transmission input shaft 146. The dual clutch transmission 52 comprises a plurality of, presently four, spur gear stages 148, 150, 152, 154, each having a fixed gear 156 co-rotationally disposed on the first or the second transmission input shaft 144, 146, and each having a shifting gear 158 rotatably disposed on the output shaft 88. The dual clutch transmission 52 comprises four spur gear stages 148, 150, 152, 154 for establishing gear stages. Specifically, a first spur gear stage 148 and a second spur gear stage 150 comprise in each case the fixed gear 156 on the first transmission input shaft 144, and in each case the shifting gear 158 on the output shaft 88. A third spur gear stage 152 and a fourth spur gear stage 154 can in each case have the fixed gear 156 on the second transmission input shaft 146, and in each case the shifting gear 158 on the output shaft 88.

The dual clutch transmission 52 moreover comprises the first coupling element 160. The first coupling element 160 is disposed on the output shaft 88, between the second and the third spur gear stage 150, 152, and is mounted on the output shaft 88. The two shifting gears 158 of the second and the third spur gear stage 150, 152 can be co-rotationally connected to the first coupling element 160, such that the first and the second transmission input shaft 144, 146 are made dependent and a winding path gear stage is formed. The second coupling element 162 can be disposed on or at the output shaft 88 between the first and the second spur gear stage 148, 150. The third coupling element 164 can be disposed on or at the output shaft 88, between the third and the fourth spur gear stage 152, 154. The shifting gear 158 of the first spur gear stage 148 can be co-rotationally connected to the output shaft 88 by the second coupling element 162. The shifting gear 158 of the fourth spur gear stage 154 can be co-rotationally connected to the output shaft 88 by the third coupling element 164.

On the drive output side, the dual clutch transmission 52 is assigned the output shaft 88. The dual clutch transmission is connected to the input shaft 86 on the input side, for example an input side of the first and the second shifting element 140, 142, for example the third input side 124. The first and/or the second transmission input shaft 144, 146 are designed as hollow shafts. The input shaft 86 is designed as a solid shaft. The second transmission input shaft 146 is disposed and/or mounted, for example freely rotatably disposed and/or mounted, in the first transmission input shaft 144, and the input shaft 86 is disposed and/or mounted, for example freely rotatably disposed and mounted, in the second transmission input shaft 146.

The reverse idler gear 300 is disposed, for example in an intervening manner, between the first or second transmission input shaft 144, 146 and the output shaft 88. The reverse idler gear 300 can be disposed between a fixed gear 156 and shifting gear 158 of one of the spur gear stages 148, 150, 152, 154. In FIG. 2, the reverse idler gear 300 is disposed in the first spur gear stage 148, for example between the fixed gear 156 and the shifting gear 158 of the first spur gear stage 148. As a result, with the dual clutch transmission 52, it is advantageously possible to implement four forward gears (of which one is a winding path gear) and two reverse gears (of which one is a winding path gear).

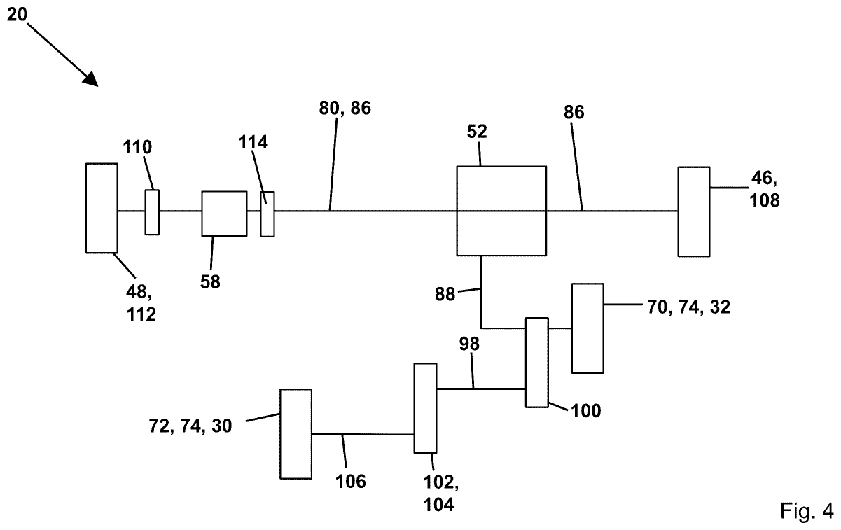

FIG. 3 shows a schematic illustration of a second example embodiment of the dual clutch transmission 52 according to the disclosure. The dual clutch transmission 52 shown in FIG. 3 corresponds substantially to the dual clutch transmission 52 shown in FIGS. 1 to 2, and therefore only details and/or points of differentiation will be discussed below. The working machine 10 and/or the drive assembly 20 illustrated in FIG. 1 can comprise the dual clutch transmission 52 illustrated in FIG. 2. The drive assembly 20 illustrated in FIGS. 4 to 11 can comprise the dual clutch transmission 52 illustrated in FIG. 3.

In FIG. 3, the reverse idler gear 300 is disposed in the second spur gear stage 150, for example between the fixed gear 156 and the shifting gear 158 of the second spur gear stage 150. As a result, with the dual clutch transmission 52, it is advantageously possible for three forward gears in the form of single-stage gears and three reverse gears, of which two are in the form of winding path gears, to be realized.

FIG. 4 shows a schematic illustration of a first example embodiment of the drive assembly 20 according to the disclosure. The drive assembly 20 shown in FIG. 4 corresponds substantially to the drive assembly 20 shown in FIGS. 1 to 3, and therefore only details and/or points of differentiation will be discussed below. The working machine 10 illustrated in FIG. 1 can comprise the drive assembly 20 illustrated in FIG. 4. The drive assembly 20 for a working machine 10 comprises the dual clutch transmission 52. The drive assembly 20, for example the dual clutch transmission 52, furthermore comprises the input shaft 86 and the output shaft 88. The input shaft 86 is connectable or connected to the third input side 124. The drive assembly 20 furthermore comprises the drive unit 58. A decoupler 114 can be disposed between the drive unit 58 and the dual clutch transmission 52. The drive unit 58 can be able to be separated from the dual clutch transmission 52 by the decoupler 114. A rotating speed and/or a torque and/or a force can thereby optionally be able to be directed into the drive assembly 20, for example the transmission device 50, by the drive unit 58. Moreover, the drive unit 58 is connectable, or connected, to the input shaft 86. The dual clutch transmission 52 is connectable or connected on the output side to the output shaft 88. The output shaft 88 can moreover be connectable, or connected, to the propulsion drive 70, for example to the rear-axle drive 74, for example the first and/or the second differential 30, 32. The output shaft 88 can likewise be connectable, or connected, to a layshaft 98, for example by way of, or through, a third transmission stage 100, for example a further spur gear stage or a further gearwheel pair, or three or more gearwheels or a further planetary gear, or any other transmission. Moreover, the layshaft 98 can be connectable, or connected, to the propulsion drive 70, for example the front-axle drive 72, for example the first differential 30. The layshaft 98 can be connectable or connected to a further shaft 106 by a fourth or by way of a fourth transmission stage 102, for example a further spur gear stage or a further gearwheel pair, or three or more gearwheels, or a further planetary transmission or any other transmission, and/or a further shifting element 104. The drive assembly 20 can, moreover, comprise the first power output 46.

The drive unit 58 can be connectable, or connected, to the first power output 46. Specifically, the drive unit 58 can be connectable, or connected, to the first power output 46 by way of, or through, the input shaft 86. The input shaft 86 can be connectable or connected to the first power output 46, for example, by a further shifting element (not shown). The first power output 46 can comprise a PTO unit 108. The PTO unit 108 can comprise a PTO transmission and/or a PTO shaft. The PTO unit 108, for example the PTO transmission, can be connected on the drive side to the input shaft 86. Moreover, the PTO unit 108, for example the PTO transmission, can be connectable, or connected, on the drive output side to the PTO shaft. The transmission device 50 and/or the dual clutch transmission can have a conduit, for example a central conduit, for the input shaft 86. The drive assembly 20 can, moreover, comprise a second power output 48. The drive unit 58 can be connectable, or connected, to the second power output 48. Specifically, the drive unit 58 can be connectable, or connected, to the second power output 48 by way of a further shaft. The drive unit 58 can be connected to the second power output 48 by way of the further shaft and/or a further shifting element 110. The second power output 48 can comprise a further PTO unit 112. The further PTO unit 112 can comprise a further PTO transmission and/or a further PTO shaft. FIGS. 4 to 7 schematically describe the drive assembly 20 and the power flux of the drive assembly 20.

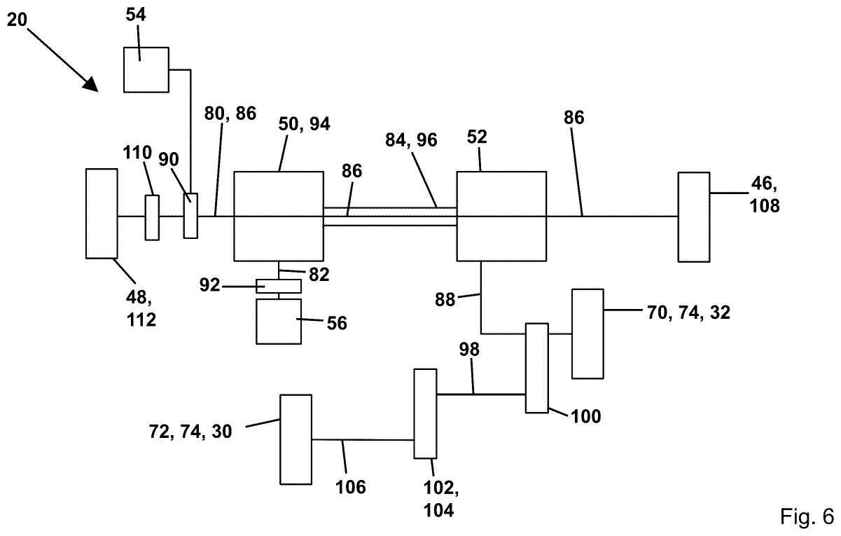

FIG. 5 shows a schematic illustration of a second example embodiment of the drive assembly 20 according to the disclosure. The drive assembly 20 shown in FIG. 5 corresponds substantially to the drive assembly 20 shown in FIGS. 1 to 4, and therefore only details and/or points of differentiation will be discussed below. The working machine 10 illustrated in FIG. 1 can comprise the drive assembly 20 illustrated in FIG. 5. The drive assembly 20 comprises the transmission device 50. The dual clutch transmission 52 is disposed in the power flux downstream of the transmission device 50. The transmission device 50 can comprise a range transmission, for example a single-stage transmission or a multi-stage transmission, or a continuously variable transmission. The transmission device 50 can also be designed as an epicyclic transmission stage 94. The transmission device 50 can have a first and/or a second input side 80, 82, and/or a first output side 84. The dual clutch transmission 52 is connectable or connected to the first output side 84 of the transmission device 50, for example by or through a third shaft 96 which can for example be designed as a hollow shaft. The drive assembly 20 furthermore comprises the input shaft 86 and the output shaft 88. The input shaft 86 can be connectable or connected to an input side of the transmission device 50, for example the first input side 80.

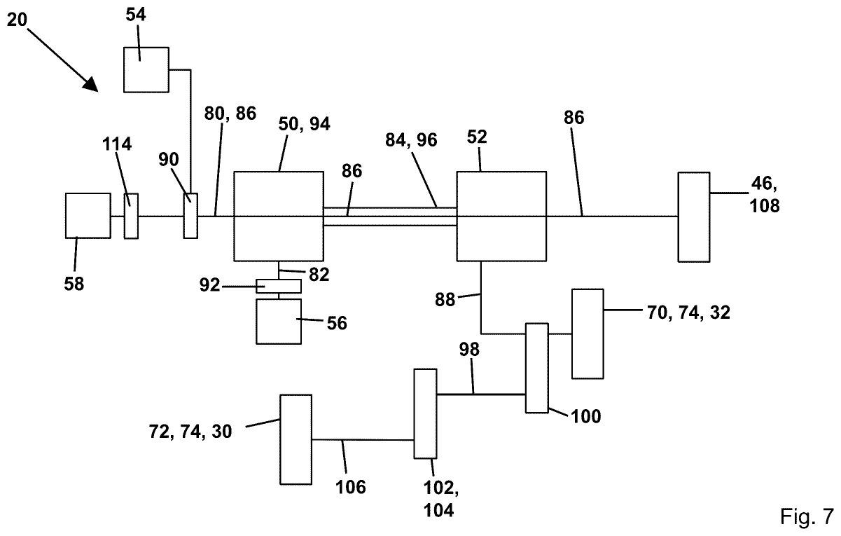

FIG. 6 shows a schematic illustration of a third example embodiment of the drive assembly 20 according to the disclosure. The drive assembly 20 shown in FIG. 6 corresponds substantially to the drive assembly 20 shown in FIGS. 1 to 5, and therefore only details and/or points of differentiation will be discussed below. The working machine 10 illustrated in FIG. 1 can comprise the drive assembly 20 illustrated in FIG. 6. The drive assembly 20 for a working machine 10 comprises the transmission device 50 with the first and the second input side 80, 82 and the first output side 84. The dual clutch transmission 52 is connectable, or connected, to the first output side 84 of the transmission device 50, for example by or through the third shaft 96. The input shaft 86 can be connectable or connected to the first input side 80. The first energy machine 54 is connected to the input shaft 86. The first energy machine 54 can be connected to the input shaft 86 directly or by way of or by or through a first transmission stage 90. The second energy machine 56 is connected to the second input side 82. The second energy machine 56 can be connected to the second input side 82 directly or by way of or by or through a second transmission stage 92. Moreover, a rotating speed and/or a direction of rotation of the first output side 84 of the transmission device 50 is settable and/or adjustable and/or actuatable, for example, a rotating speed and/or a direction of rotation of the first output side 84 of the transmission device 50 is settable and/or adjustable and/or actuatable by the second energy machine 56. In other words, a rotating speed and/or a direction of rotation, and/or for example a rotation, of the second energy machine 56 can be settable and/or adjustable and/or actuatable, for example in such a way that a rotating speed and/or a direction of rotation, and/or for example a rotation, of the first output side 84 of the transmission device 50 is settable and/or adjustable and/or actuatable. The drive unit 58 and/or the first energy machine 54 can be connectable or connected to the first power output 46. Specifically, the drive unit 58 and/or the first energy machine 54 can be connectable or connected to the first power output 46 by way of the or through the input shaft 86. The input shaft 86 can be connectable or connected to the first power output 46, for example, by a further shifting element (not shown). The transmission device 50 is disposed in the torque flux and/or power flux upstream of the dual clutch transmission 52.

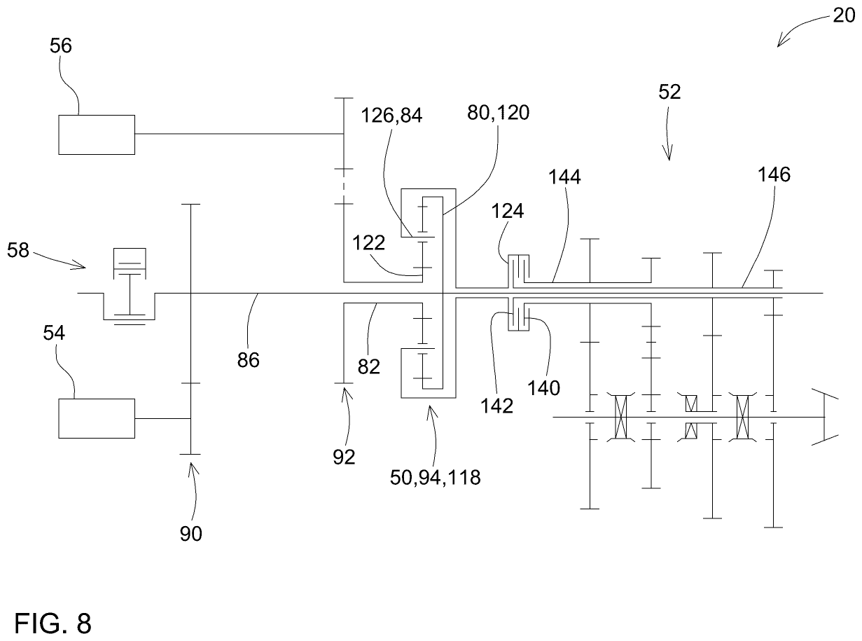

FIG. 7 shows a schematic illustration of the fourth example embodiment of the drive assembly 20 according to the disclosure. The drive assembly 20 shown in FIG. 7 corresponds substantially to the drive assembly 20 shown in FIGS. 1 to 6, and therefore only details and/or points of differentiation will be discussed below. The working machine 10 illustrated in FIG. 1 can comprise the drive assembly 20 illustrated in FIG. 7. The drive unit 58 is connectable, or connected, to the input shaft 86. The decoupler 114 is disposed between the drive unit 58 and the transmission device 50, but can alternatively be disposed between the drive unit 58 and the first energy machine 54.

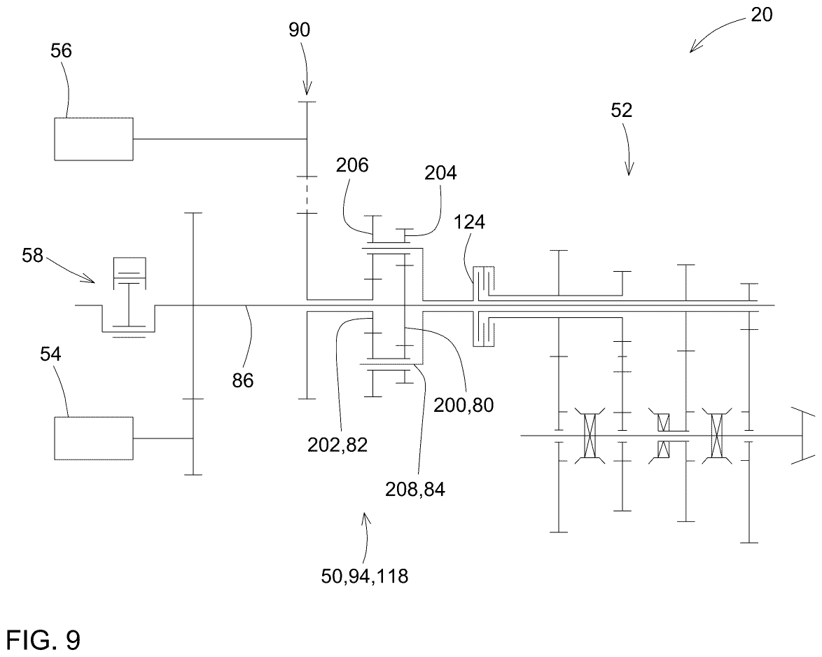

FIG. 8 shows a schematic illustration of the fifth example embodiment of the drive assembly 20 according to the disclosure. The drive assembly 20 shown in FIG. 8 corresponds substantially to the drive assembly 20 shown in FIGS. 1 to 7, and therefore only details and/or points of differentiation will be discussed below. The working machine 10 illustrated in FIG. 1 can comprise the drive assembly 20 illustrated in FIG. 8. The dual clutch transmission 52 in FIG. 8 corresponds substantially to the dual clutch transmission 52 shown in FIGS. 1 to 7, and therefore only details and/or points of differentiation will be discussed below. The transmission device 50, for example the epicyclic transmission stage 94, comprises a planetary transmission, for example a first planetary transmission 118, and/or is designed as a planetary transmission, for example the first planetary transmission 118. The first input side 80 of the transmission device 50, for example of the epicyclic transmission stage 94, for example of the first planetary transmission 118, is connected to the input shaft 86. The first input side 80 of the first planetary transmission 118 is connected to a first ring gear 120 of the first planetary transmission 118. The first ring gear 120 is connected to the input shaft 86, and therefore for example to the first energy machine 54 and the drive unit 58. The second input side 82 of the transmission device 50, for example of the epicyclic transmission stage 94, for example of the first planetary transmission 118, is connected to the second energy machine 56. The second input side 82 of the transmission device 50, for example of the epicyclic transmission stage 94, for example of the first planetary transmission 118, is connected to a first sun 122 of the first planetary transmission 118. The first sun 122 is connected to the second energy machine 56, for example through or by a shaft and/or the second transmission stage 92. The first output side 84 of the transmission device 50, for example of the epicyclic transmission stage 94, for example of the first planetary transmission 118, is connected to the dual clutch transmission 52, for example to the third input side 124 of the dual clutch transmission 52. The first planet carrier 126 of the first planetary transmission 118 is connected to the dual clutch transmission 52, for example the third input side 124 of the dual clutch transmission 52, by way of a shaft, for example.

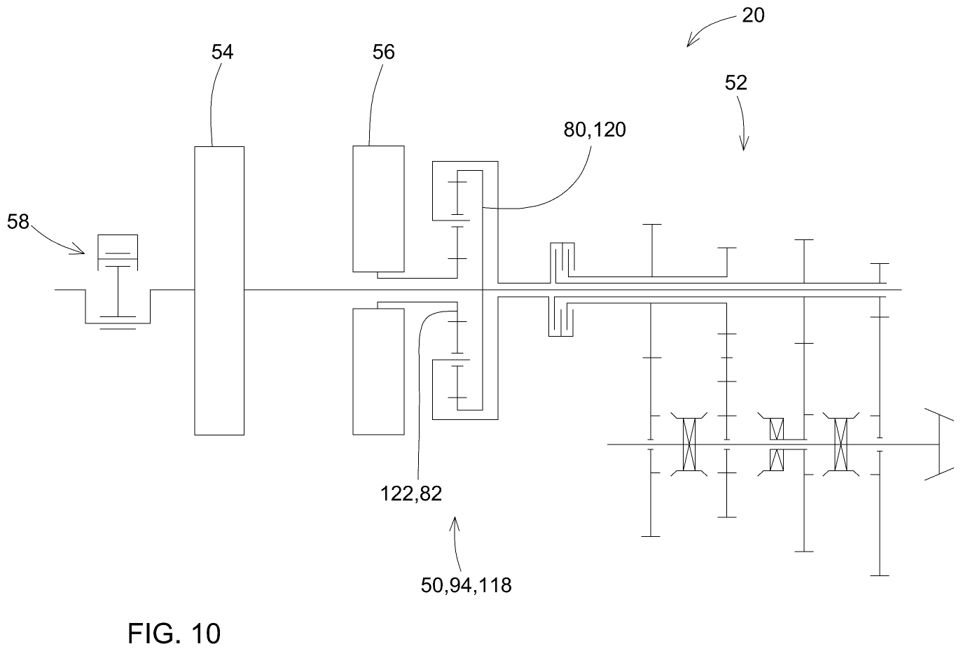

FIG. 9 shows a schematic illustration of the sixth example embodiment of the drive assembly 20 according to the disclosure. The drive assembly 20 shown in FIG. 9 corresponds substantially to the drive assembly 20 shown in FIGS. 1 to 8, and therefore only details and/or points of differentiation will be discussed below. The working machine 10 illustrated in FIG. 1 can comprise the drive assembly 20 illustrated in FIG. 9. The dual clutch transmission 52 in FIG. 9 corresponds substantially to the dual clutch transmission 52 shown in FIGS. 1 to 8, and therefore only details and/or points of differentiation will be discussed below. As an alternative to FIG. 8, the transmission device 50 in FIG. 9 comprises for example the epicyclic transmission stage 94, for example the first planetary transmission 118, a first and a second sun 200, 202 and a first and a second planetary set 204, 206 and a first planet carrier 208. The first and the second planetary set 204, 206 are disposed on the first planet carrier 208. The first sun 200 and the first planetary set 204 are engaged in one another and/or mesh with one another. The second sun 202 and the second planetary set 206 are also engaged in one another and/or mesh with one another. The first input side 80 of the transmission device 50, for example of the epicyclic transmission stage 94, for example of the first planetary transmission 118, is connected to the first sun 200 of the first planetary transmission 118. The first sun 80 is, moreover, connected to the input shaft 86. The first sun 80 can be connected to the input shaft 86, for example, with a or through a shaft. The second input side 82 of the transmission device 50, for example of the epicyclic transmission stage 94, for example of the first planetary transmission 118, is connected to the second sun 202 of the first planetary transmission 118. The second sun 202 is connected to the second energy machine 56. The second sun 202 can be connected to the second energy machine 56 through or by a shaft and/or the second transmission stage 90. The first output side 84 of the transmission device 50, for example of the epicyclic transmission stage 94, for example of the first planetary transmission 118, is connected to the dual clutch transmission 52, for example to the third input side 124 of the dual clutch transmission 52. The transmission device 50, for example the epicyclic transmission stage 94, for example the first planetary transmission 118, is disposed in the power flux upstream of the dual clutch transmission 52.

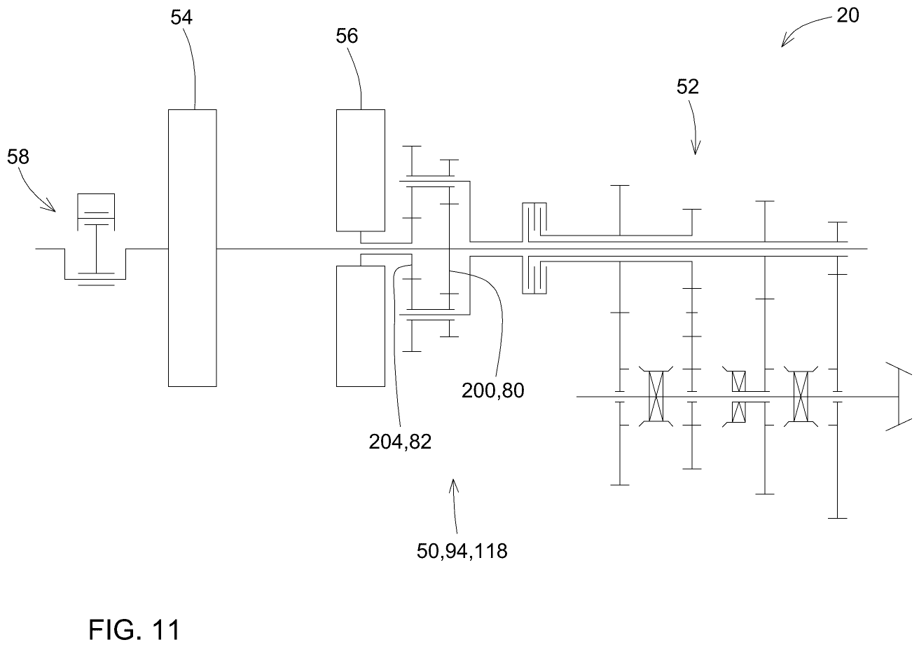

FIGS. 10 and 11 show schematic illustrations of further example embodiments of the drive assembly 20 according to the disclosure. The drive assembly 20 shown in FIGS. 10 and 11 correspond substantially to the drive assembly 20 shown in FIGS. 1 to 9, and therefore only details and/or points of differentiation will be discussed below. The working machine 10 illustrated in FIG. 1 can comprise the drive assembly 20 illustrated in FIGS. 10 and 11. The dual clutch transmission 52 in FIGS. 10 and 11 corresponds substantially to the dual clutch transmission 52 shown in FIGS. 1 to 9, and therefore only details and/or points of differentiation will be discussed below. In this context, FIG. 10 corresponds substantially to FIG. 8, and FIG. 11 to FIG. 9.

A substantial difference is that the first and second energy machines in FIGS. 10 and 11 are embodied for example in an in-line construction mode. In the in-line construction mode, the first energy machine 54 can be connected on the output side to the input shaft 86; for example, a rotor of the first energy machine 54, for example an internal rotor, can be connected to the input shaft 86. However, the first energy machine 54 can also be connected on the output side to the input shaft 86 by a or through a shaft. The first energy machine 54 can be embodied as a torque motor. In this embodiment, the first energy machine 54 drives the input shaft 86 directly. The second energy machine 56 can be connected on the output side to the second input side 82 of the transmission device 50, for example the epicyclic transmission stage 94, for example the first planetary transmission 118; for example, a rotor of the second energy machine 56, for example an internal rotor, can be connected to the second input side 82, for example by a or through a shaft. The second energy machine 56 can be embodied as a torque motor.

Specifically, in FIG. 10, the first energy machine 54 is connected on the output side to the first ring gear 120 of the transmission device 50, for example the epicyclic transmission stage 94, for example the first planetary transmission 118. The first energy machine 54 directly drives the first input side 80, for example the first ring gear 120. Specifically, in FIG. 9, the second energy machine 56 is connected on the output side to the first sun 122 of the transmission device 50, for example the epicyclic transmission stage 94, for example the first planetary transmission 118. In this embodiment, the second energy machine 56 drives directly the second input side 82, for example the first sun 120.

Specifically, in FIG. 11, the first energy machine 54 is connected on the output side to the first sun 200 of the transmission device 50, for example the epicyclic transmission stage 94, for example the first planetary transmission 118. The first energy machine 54 drives directly the first input side 80, for example the first sun 200. Specifically, in FIG. 11, the second energy machine 56 is connected on the output side to the second sun 204 of the transmission device 50, for example the epicyclic transmission stage 94, for example the first planetary transmission 118. In this embodiment, the second energy machine 56 drives directly the second input side 82, for example the second sun 204.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A dual clutch transmission for a drive assembly of a working machine, comprising:
a first shifting element connected to a first transmission input shaft;
a second shifting element connected to a second transmission input shaft; and
a plurality of spur gear stages, the first transmission input shaft connected to an output shaft by at least one of the plurality of the spur gear stages, second transmission input shaft connected to the output shaft by at least one of the plurality of the spur gear stages, and the plurality of spur gear stages including a first spur gear stage having a first fixed gear disposed on the first transmission input shaft, a first shifting gear disposed on the output shaft, and a reverse idler gear disposed between the first fixed gear and the first shifting gear.

2. The dual clutch transmission of claim 1, wherein:
the plurality of spur gear stages includes a second spur gear stage, a third spur gear stage, and a fourth spur gear stage;
the second spur gear stage has a second fixed gear disposed on the first transmission input shaft and a second shifting gear disposed on the output shaft;
the third spur gear stage has a third fixed gear disposed on the second transmission input shaft and a third shifting gear disposed on the output shaft; and
the fourth spur gear stage has a fourth fixed gear disposed on the second transmission input shaft and a fourth shifting gear disposed on the output shaft.

3. A drive assembly for a working machine, comprising:
a dual clutch transmission comprising:
a first shifting element connected to a first transmission input shaft;
a second shifting element connected to a second transmission input shaft; and
a plurality of spur gear stages, the first transmission input shaft connected to an output shaft by at least one of the plurality of the spur gear stages, second transmission input shaft connected to the output shaft by at least one of the plurality of the spur gear stages, and the plurality of spur gear stages including a first spur gear stage having a first fixed gear disposed on the first transmission input shaft, a first shifting gear disposed on the output shaft, and a reverse idler gear disposed between the first fixed gear and the first shifting gear; and
a range transmission disposed in the power flux upstream of the dual clutch transmission.

4. The drive assembly of claim 3, wherein the range transmission includes one of a single-stage transmission, a multi-stage transmission, or a continuously variable transmission.

5. A drive assembly of claim 4, further comprising:
an input shaft;
a first energy machine connected to the input shaft; and
a second energy machine;
the range transmission including a first input side, a second input side connected to the second energy machine, and a first output side connected to the dual clutch transmission.

6. The drive assembly of claim 5, further comprising:
a drive unit connected to the input shaft.

7. The drive assembly of claim 5, wherein the range transmission includes an epicyclic transmission stage.

8. The drive assembly of claim 5, further comprising:
a set of power electronics by which electrical power is transmissible between the first energy machine and the second energy machine.

9. The drive assembly of claim 5, further comprising:
a decoupler disposed between the drive unit and the range transmission or between the drive unit and the first energy machine.

10. The drive assembly of claim 5, further comprising:
a control unit, including a processor and memory, configured to operate the drive assembly.

11. The drive assembly of claim 5, wherein the input shaft is connected to a first power output including a PTO shaft.

12. A working machine including a drive assembly, comprising:
a dual clutch transmission including
a first shifting element connected to a first transmission input shaft,
a second shifting element connected to a second transmission input shaft, and
a plurality of spur gear stages, the first transmission input shaft connected to an output shaft by at least one of the plurality of the spur gear stages, second transmission input shaft connected to the output shaft by at least one of the plurality of the spur gear stages, and the plurality of spur gear stages including a first spur gear stage having a first fixed gear disposed on the first transmission input shaft, a first shifting gear disposed on the output shaft, and a reverse idler gear disposed between the first fixed gear and the first shifting gear. ; and
a range transmission disposed in the power flux upstream of the dual clutch transmission.

13. The working machine of claim 12, wherein the range transmission includes one of a single-stage transmission, a multi-stage transmission, or a continuously variable transmission.

14. The working machine of claim 13, further comprising:
an input shaft;
a first energy machine connected to the input shaft; and
a second energy machine;
the range transmission including a first input side, a second input side connected to the second energy machine, and a first output side connected to the dual clutch transmission.

15. The working machine of claim 14, further comprising:
a drive unit connected to the input shaft.

16. The working machine of claim 14, wherein the range transmission includes an epicyclic transmission stage.

17. The working machine of claim 14, further comprising:
a set of power electronics by which electrical power is transmissible between the first energy machine and the second energy machine.

18. The working machine of claim 14, further comprising:
a decoupler disposed between the drive unit and the range transmission or between the drive unit and the first energy machine.

19. The working machine of claim 14, further comprising:
a control unit, including a processor and memory, configured to operate the drive assembly.

20. The working machine of claim 14, wherein the input shaft is connected to a first power output including a PTO shaft.
